(19) United States
(12) Patent Application Publication
(10) Pub. No.: US 2016/0178340 A1
(43) Pub. Date: Jun. 23, 2016

(54) MEASUREMENT AND OPERATION AUXILIARY DEVICE

(71) Applicant: NATIONAL CHUNG SHAN INSTITUTE OF SCIENCE AND TECHNOLOGY, Longtan Township (TW)

(72) Inventors: CHUNG-YI CHU, LONGTAN TOWNSHIP (TW); CHAO-CHUNG HO, LONGTAN TOWNSHIP (TW); CHIEN-YING HO, LONGTAN TOWNSHIP (TW); MAU-YI HUANG, LONGTAN TOWNSHIP (TW); DAR-PING JUANG, LONGTAN TOWNSHIP (TW); WEI-CHUNG CHEN, LONGTAN TOWNSHIP (TW); SHYH-JANG SUN, LONGTAN TOWNSHIP (TW); CHENG-HUAN WANG, LONGTAN TOWNSHIP (TW)

(21) Appl. No.: 14/578,661

(22) Filed: Dec. 22, 2014

(51) Int. Cl. G01B 5/00; F16B 1/00; F16B 47/00; F16M 13/02

(52) U.S. Cl. CPC G01B 5/0004; F16M 13/022; F16B 1/00; F16B 47/00; F16B 2001/0035

(57) ABSTRACT

A measurement and operation auxiliary device, for supporting a length measurement tool disposed on an object under test, especially when measuring dimensions of a large object under test with a large length measurement tool, includes a fastening element, a connection shaft, and a support unit. The fastening element is unfastenably coupled to the object under test. The connection shaft is disposed on the fastening element. The support unit has a receiving chamber and a through hole. The connection shaft is penetratingly disposed in the through hole to allow the support unit to be rotatably coupled to the fastening element. The receiving chamber receives the length measurement tool. With the measurement and operation auxiliary device, the bulky length measurement tool can be fixed to a location suitable for measuring the dimensions of the large object under test without another co-worker and in a convenient, labor-saving manner.

### FIELD OF TECHNOLOGY

The present invention relates to measurement and operation auxiliary devices, and more particularly, to a device mounted on an object under test to lend assistance and support to a length measurement tool.

### BACKGROUND

In the course of the mechanical processing of a workpiece, the processing machine has to undergo a verification process performed to verify the measurements of the workpiece and thus check for its compliance with production specifications. A large workpiece which is one meter long, wide, or high is measured with a large length measurement tool, such as a vernier caliper or a digital caliper, during the verification process. The length measurement tool is pressed against the workpiece to be measured, and then a jaw of the main scale and a jaw of the vernier scale clamp or press against the workpiece to be measured, so as to measure the workpiece.

In a conventional verification process performed on workpiece measurement, a length measurement tool for use with a large workpiece is long and heavy. In view of this, the conventional verification process is carried out by two co-workers; one co-worker operates the main scale and the vernier scale, whereas the other co-worker holds the length measurement tool to ensure that the length measurement tool is fixed to a location conducive to measurement. As a result, the relative positions of the workpiece under test and the length measurement tool are unlikely to change, and in consequence either at least an additional co-worker or an additional support device is required to perform the verification process, thereby posing a problem with a lack of ease of operation and a waste of manpower.

Alternatively, a support device, such as a hook or a brace, is temporarily mounted on the workpiece under test to lend support to the length measurement tool. However, conventional support devices affixed to an object under a magnetic force, such as magnetic dual hangers of Japan published patent application 1997-140547, a magnetic hook of Japan published patent application 2005-218487, and a magnetic hanger of Japan published patent application 1995-284439, have their own drawbacks. For example, the hook structure of the conventional support devices is unable to rotate on a plane parallel to the surface of a workpiece under test and thus cannot rotate by being driven as a result of the adjustable rotation of the length measurement tool to an extent conducive to measurement, and in consequence the support devices must be rotatably adjusted by hand, thereby lacking ease of use.

### SUMMARY

It is an objective of the present invention to provide a measurement and operation auxiliary device whereby a large object under test can be measured easily by one and only one worker.

In order to achieve the above and other objectives, the present invention provides a measurement and operation auxiliary device for supporting a length measurement tool disposed on an object under test. The measurement and operation auxiliary device includes a fastening element, a connection shaft, and a support unit. The fastening element is unfastenably coupled to the object under test. The connection shaft is disposed on the fastening element. The support unit has a receiving chamber and a through hole. The connection shaft is penetratingly disposed in the through hole to allow the support unit to be rotatably coupled to the fastening element, wherein the receiving chamber receives the length measurement tool.

The measurement and operation auxiliary device further comprises a handle, and the handle is disposed on the support unit.

Regarding the measurement and operation auxiliary device, a protective layer is disposed on an inner wall of the receiving chamber.

Regarding the measurement and operation auxiliary device, the protective layer is made of teflon or rubber.

Regarding the measurement and operation auxiliary device, the fastening element is a magnetic fastener or a vacuum fastener.

Regarding the measurement and operation auxiliary device, the fastening element is a hook and has a retractable engaging plate with an adjustable length so as to be hung at objects of different sizes.

Regarding the measurement and operation auxiliary device, an end of the connection shaft protrudes from the support unit and has an external thread for fastening and fixing a nut in place.

Accordingly, to measure the dimensions of an object under test, especially measuring the dimensions of a large object under test with a large length measurement tool, a measurement and operation auxiliary device of the present invention can be coupled to the object under test to lend assistance and support to the length measurement tool at a location suitable for measuring the dimensions of the object under test in a convenient, labor-saving manner, so as to overcome drawbacks of the prior art, including the difficulty in fixing a length measurement tool to a location suitable for measuring the dimensions of an object under test in the situation where both the object under test and the length measurement tool are bulky, and the difficulty in measuring the dimensions of an object under test without another co-worker.

### BRIEF DESCRIPTION

Objectives, features, and advantages of the present invention are hereunder illustrated with specific embodiments in conjunction with the accompanying drawings, in which:

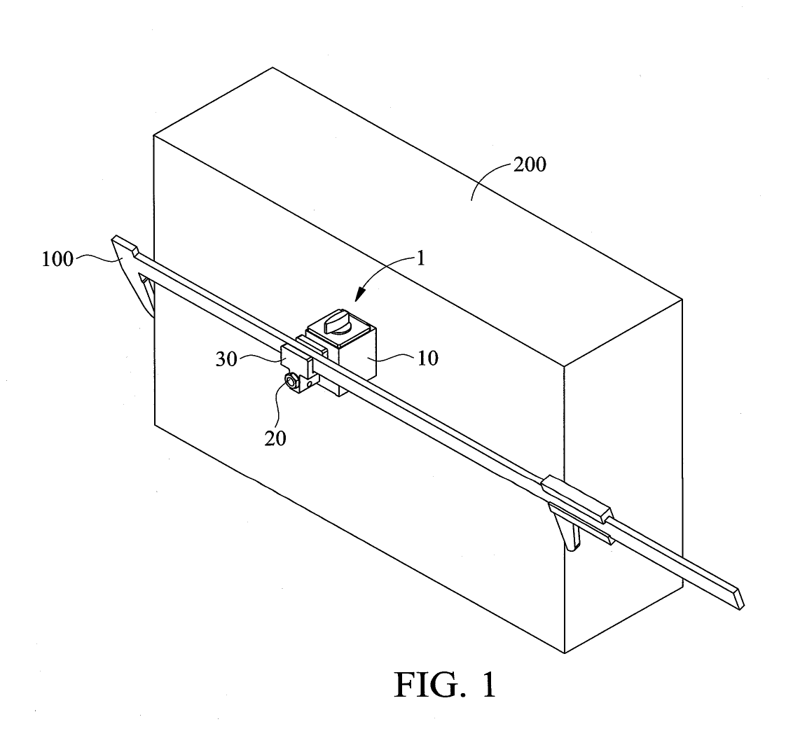

FIG. 1 is a schematic view of the operation of a measurement and operation auxiliary device according to the embodiment of the present invention;

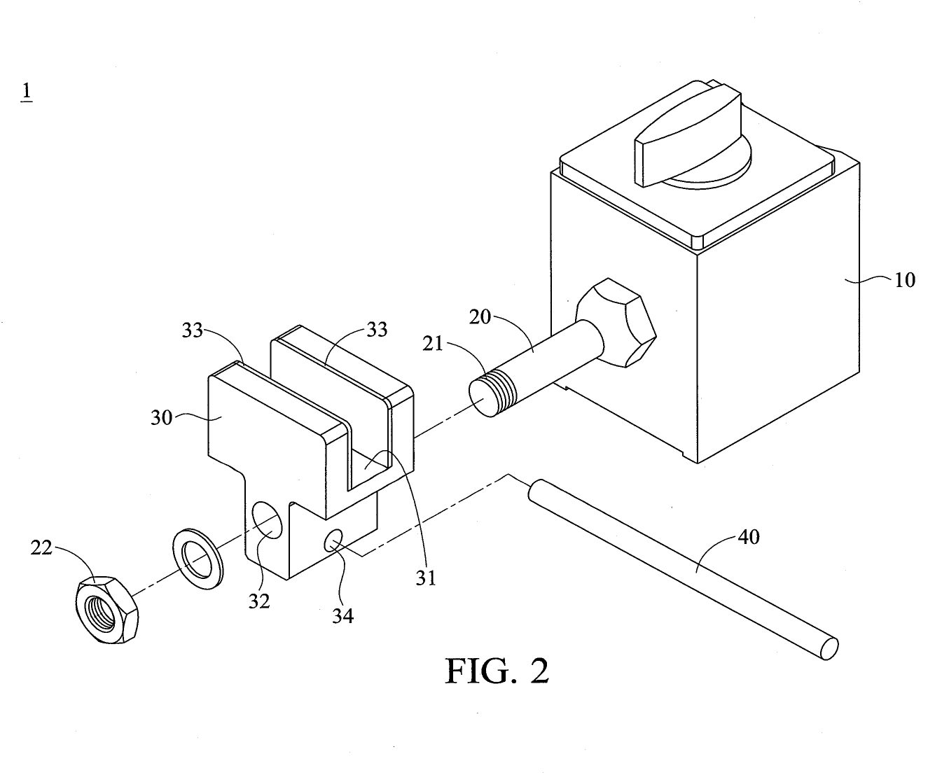

FIG. 2 is an exploded view of the measurement and operation auxiliary device according to the embodiment of the present invention;

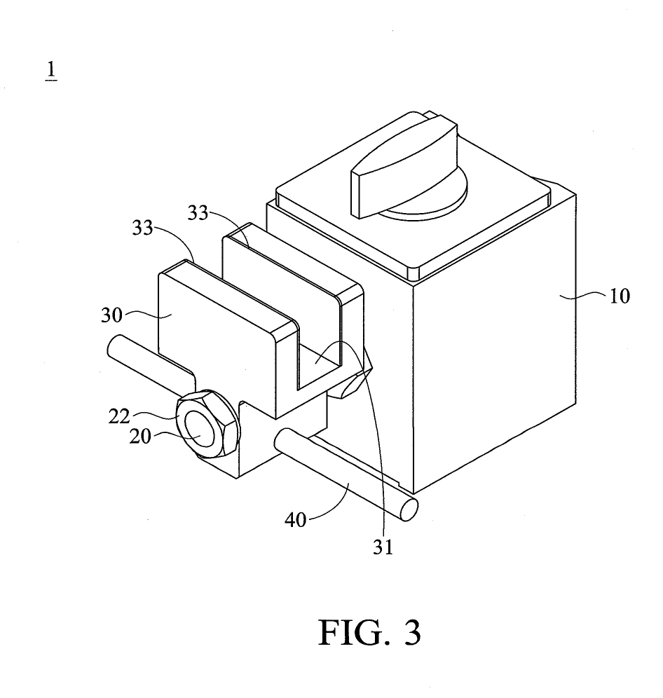

FIG. 3 is a structural schematic view of the measurement and operation auxiliary device according to the embodiment of the present invention;

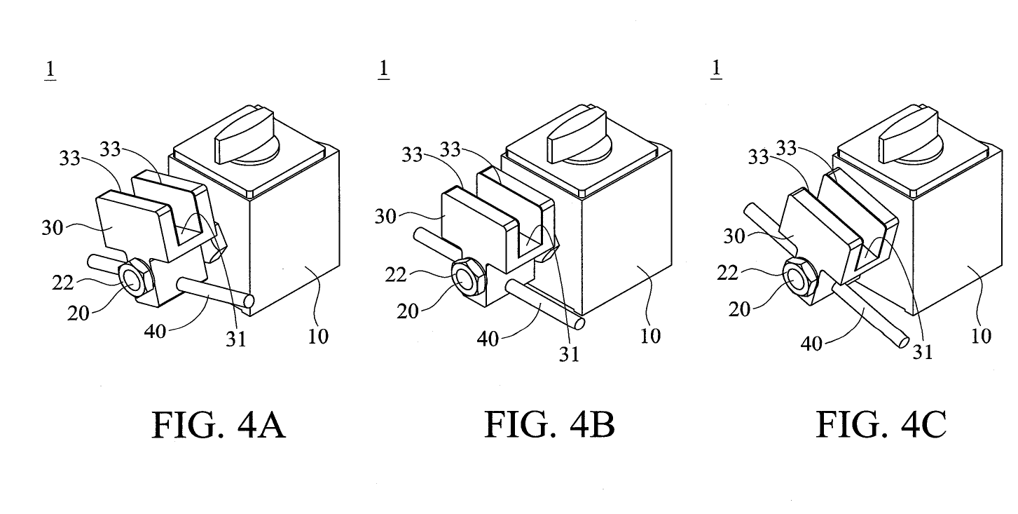

FIGS. 4(A) through 4(C) are structural schematic views of the measurement and operation auxiliary device for use in counterclockwise rotation and clockwise rotation;

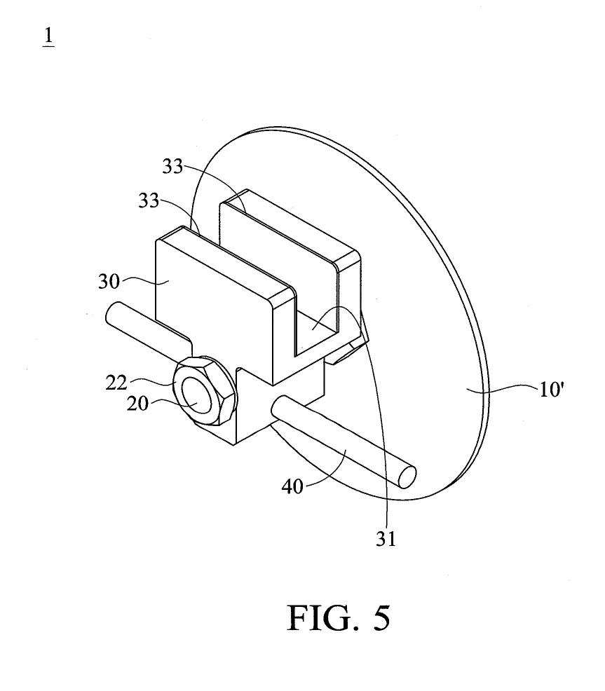

FIG. 5 is a structural schematic view of the measurement and operation auxiliary device, wherein a fastening element is provided in the form of a vacuum fastener according to the embodiment of the present invention; and

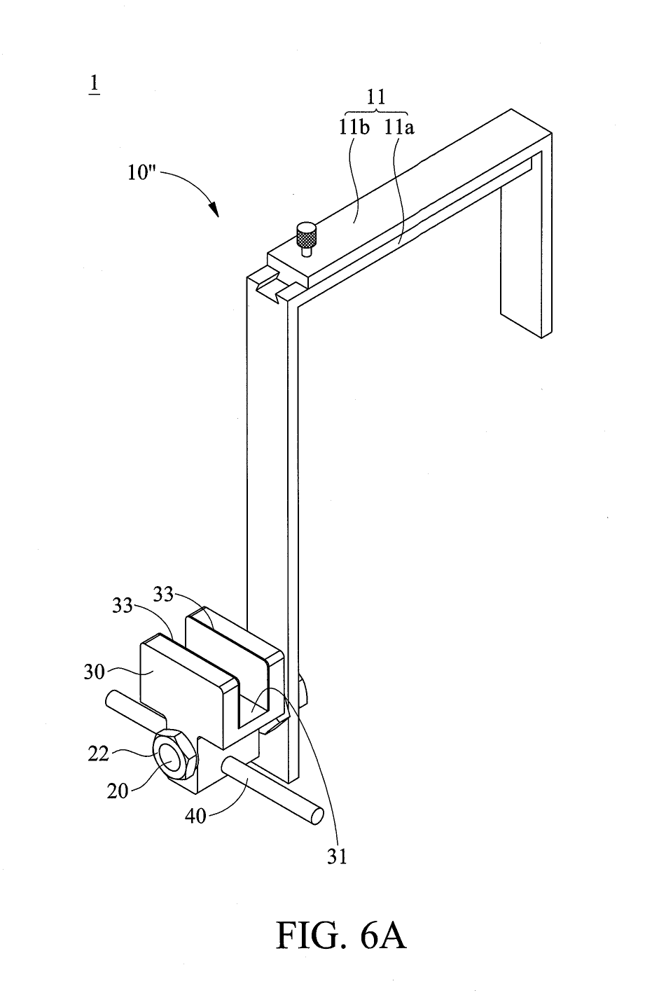

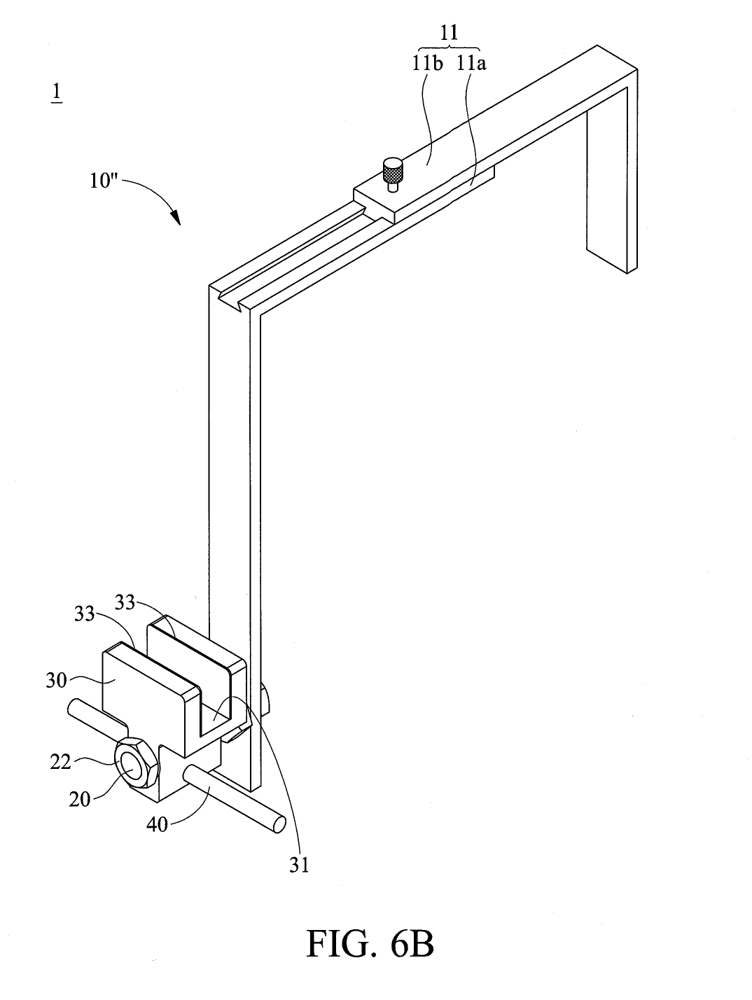

FIGS. 6(A) and 6(B) are structural schematic views of the measurement and operation auxiliary device, wherein the fastening element is provided in the form of a hook according to the embodiment of the present invention.

### DETAILED DESCRIPTION

Referring to FIG. 1, in the embodiment of the present invention, a measurement and operation auxiliary device 1 enables a length measurement tool 100 to be underpinned by an object under test 200 (OUT) and especially applies to measuring a large OUT 200 which is at least a meter long. The measurement and operation auxiliary device 1 lends assistance and support to the length measurement tool 100 to thereby enable a user to operate the length measurement tool 100 and measure the OUT 200. Since the measurement and operation auxiliary device 1 lends assistance and support to the length measurement tool 100 underpinned by the OUT 200 to be measured, it dispenses with the hassles of requiring a co-worker to lend assistance and support to the length measurement tool 100. In practice, the length measurement tool 100 is a vernier caliper or a digital caliper.

Referring to FIG. 2 and FIG. 3, the measurement and operation auxiliary device 1 comprises a fastening element 10, a connection shaft 20, and a support unit 30. The fastening element 10 is unfastenably coupled to the OUT 200. The connection shaft 20 is disposed on the fastening element 10. The support unit 30 has a receiving chamber 31 and a through hole 32. The connection shaft 20 is penetratingly disposed in the through hole 32 to allow the support unit 30 to be rotatably coupled to the fastening element 10. The receiving chamber 31 receives the length measurement tool .

In this embodiment, the length measurement tool 100 is received in the receiving chamber 31 to support the length measurement tool 100 in a manner to position the length measurement tool 100 at a location suitable for measuring the length of the OUT 200. A protective layer 33 is disposed on the inner wall of the receiving chamber 31 to protect the inner wall of the receiving chamber 31 against collision and friction while the user is moving or operating the length measurement tool 100, thereby protecting the surfaces of the length measurement tool 100 and the support unit 30 against wear and tear. The protective layer 33 is made of teflon or rubber.

In this embodiment, the connection shaft 20 is penetratingly disposed in the through hole 32, and one end of the connection shaft 20 protrudes from the support unit 30 and has an external thread 21 for fastening and fixing a nut 22 in place, such that the support unit 30 is rotatably coupled to the fastening element 10. The support unit 30 rotates about the connection shaft 20 by a maximum of 360°. Referring to FIGS. 4(A) through 4(C), the support unit 30 is capable of undergoing counterclockwise rotation and clockwise rotation; hence, to start operating the measurement and operation auxiliary device 1, all it needs to do is couple the fastening element 10 to the OUT 200, rotate the support unit 30 for the sake of adjustment, and lend support to the length measurement tool so that the length measurement tool gets fixed to a location conducive to measurement. The present invention does not put any limit on the position of the support unit 30 relative to the fastening element 10. Moreover, the support unit 30 is rotatable for the sake of adjustment and thus conducive to the quick adjustment of the length measurement tool until the length measurement tool attains a required angle of inclination in the course of measurement.

In this embodiment, the user either rotates the support unit 30 by hand or rotates the length measurement tool 100 to thereby drive the support unit 30 to rotate. Moreover, the support unit 30 further comprises a handle 40. The handle 40 is disposed on the support unit 30 and gripped by the user to rotate the support unit 30 and the length measurement tool 100. The handle 40 comes in the form of a rod fixed inside an opening 34 at the support unit 30.

As regards the measurement and operation auxiliary device 1 of this embodiment, the fastening element 10 is provided in the form of a magnetic fastener. The magnetic fastener exhibits magnetism and thus is attracted to the OUT 200 which manifests ferromagnetism. The fastening element 10 which is provided in the form of a magnetic fastener has an advantage—it can be installed quickly and easily. Moreover, the fastening element 10 is not limited to the magnetic fastener. Referring to FIG. 5, a fastening element 10′ is provided in the form of a vacuum fastener. The vacuum fastener can be affixed to the OUT 200, if the vacuum fastener is squeezed while being pressed against the OUT 200 until the internal pressure of the vacuum fastener becomes less than the atmospheric pressure. For this reason, the fastening element 10′ is suitable for use with the OUT 200 which has a flat surface and is made of any material which does not manifest ferromagnetism. Moreover, referring to FIGS. 6(A) and 6(B), a fastening element 10″ is provided in the form of a hook, and the hook has a retractable engaging plate 11. The retractable engaging plate 11 is of a length which is adjustable to allow the fastening element 10″ to be hung at objects of different sizes. For example, the retractable engaging plate 11 has a fixed segment 11a and an extensible segment 11b. The fixed segment 11a has a groove, whereas the extensible segment 11b has a rail. The rail of the extensible segment 11b corresponds in position to the groove of the fixed segment 11a. Hence, the extensible segment 11b can move along the fixed segment 11a to change the length of the retractable engaging plate 11, thereby allowing the fastening element 10″ to be hung at objects of different sizes.

Accordingly, to measure the dimensions of an object under test, especially measuring the dimensions of a large object under test with a large length measurement tool, a measurement and operation auxiliary device of the present invention can be coupled to the object under test to lend assistance and support to the length measurement tool at a location suitable for measuring the dimensions of the object under test in a convenient, labor-saving manner, so as to overcome drawbacks of the prior art, including the difficulty in fixing a length measurement tool to a location suitable for measuring the dimensions of an object under test in the situation where both the object under test and the length measurement tool are bulky, and the difficulty in measuring the dimensions of an object under test without another co-worker.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A measurement and operation auxiliary device, for supporting a length measurement tool disposed on an object under test, comprising:
a fastening element unfastenably coupled to the object under test;
a connection shaft disposed on the fastening element; and
a support unit having a receiving chamber and a through hole, with the connection shaft penetratingly disposed in the through hole to allow the support unit to be rotatably coupled to the fastening element, wherein the receiving chamber receives the length measurement tool.

2. The measurement and operation auxiliary device of claim 1, further comprising a handle disposed on the support unit.

3. The measurement and operation auxiliary device of claim 1, wherein a protective layer is disposed on an inner wall of the receiving chamber.

4. The measurement and operation auxiliary device of claim 3, wherein the protective layer is made of one of teflon and rubber.

5. The measurement and operation auxiliary device of claim 1, wherein the fastening element is one of a magnetic fastener and a vacuum fastener.

6. The measurement and operation auxiliary device of claim 1, wherein the fastening element is a hook and has a retractable engaging plate with an adjustable length so as to be hung at objects of different sizes.

7. The measurement and operation auxiliary device of claim 1, wherein an end of the connection shaft protrudes from the support unit and has an external thread for fastening and fixing a nut in place.
